(19) United States
(12) Patent Application Publication
(10) Pub. No.: US 2009/0020187 A1
(43) Pub. Date: Jan. 22, 2009

(54) METHOD AND APPARATUS FOR PROTECTING METAL FROM OXIDATON

(76) Inventors: Steven W. Russell, Knoxville, TN (US); Jerrid S. Holt, Knoxville, TN (US); Jonathan S. Morrell, Farragut, TN (US)

Correspondence Address: BWXT - Y12, LLC;LUEDEKA, NEELY & GRAHAM, P.C., P.O. BOX 1871, KNOXVILLE, TN, 37901, US

(21) Appl. No.: 11/778,859

(22) Filed: Jul. 17, 2007

(51) Int. Cl. C23C 22/02; B05C 9/14

(52) U.S. Cl. 148/281; 118/58; 148/240; 148/282; 148/283

(57) ABSTRACT

An apparatus and process for protecting metal from oxidation during metal forming operations. A salt is deposited onto at least a portion of a surface of the metal. The salt is heated in a protective environment until the salt melts on the metal to form a coated metal. The protective environment may then be removed and the coated metal may be exposed to an active environment. The coated metal may then be formed using standard metal forming processes. In alternative embodiments salts are selected for particular melting and vaporizing temperatures. An automated apparatus for coating a metal object with a salt may be provided. An applicator is configured to deposit the salt onto a surface of the metal object to form a salted metal object. A furnace is configured to receive the salted metal object and to melt at least a portion of the salt on the surface of the salted metal object. A conveyor system is configured to transport the metal object into and out of the applicator and configured to transport the salted metal object into and out of the furnace.

### GOVERNMENT RIGHTS

The U.S. Government has rights to this invention pursuant to contract number DE-AC05-00OR22800 between the U.S. Department of Energy and BWXT Y-12, L.L.C.

### FIELD

This invention relates to the field of metal working. More particularly, this invention relates to processes for forming metal that protects metal from oxidation.

### BACKGROUND

Metal forming, as used herein, refers to the activity of reshaping the physical contours of a metal object. Metal forming includes such activities as bending, rolling, stamping, forging, extruding, spinning, swaging, drawing, pressing, flattening, and similar operations as well as heat treating processes that are associated with metal forming such as annealing, stress relieving, hardening and tempering as well as metal operations such as cutting, punching, turning, grinding, sawing, shearing, and so forth. Metal forming, as used herein, does not include metal treating operations that change the chemical properties of metals such as nitriding, pickling, carburizing, and so forth. Metal forming, as used herein, does not refer to metal bonding operations such as welding, soldering or brazing.

Many metal forming operations are conducted at elevated temperatures to enhance the workability of the metal. An unfortunate consequence of exposure to elevated temperatures with many metals is that the metal may oxidize, producing undesirable surface characteristics. The remediation of these surface characteristics is expensive and time consuming. Traditionally, metal forming operations are often performed in a vacuum, or in a reducing atmosphere, or in an inert environment in order to prevent oxidation of the metal. However, establishing and maintaining such an environment may involve purging ambient air from space around the forming tools and then continuously flooding the space with argon, nitrogen, or other inert or reducing gas. Such preventive measures are expensive and time consuming.

Another difficulty with metal forming operations is that oftentimes there are delays between the manufacturing processes. For example, billets of metal may be cast at a foundry and put into inventory. Then months later the billets are shipped to a rolling mill where they are formed into bars and put into inventory. Then months later the bars are shipped to an extruder where they are drawn into wire. Exposure to air, even at ambient temperature, for these extended periods of time causes undesirable oxidation of the surfaces of certain metals.

What is needed, therefore, is an improved process for metal forming that minimizes oxidation of the metal.

### SUMMARY

The present invention provides various devices and methods for protecting metal from oxidation. One embodiment provides a process that includes depositing a solid salt onto at least a portion of a surface of a metal. In a further step the solid salt and the at least a portion of the surface of the metal are heated in a protective environment until the solid salt melts on the metal to form a coated metal region. Subsequently the coated metal region is exposed to an active environment.

Another method embodiment is provided for protecting a metal from oxidation where the metal has a metal oxidation sensitivity temperature T₂. In one step a solid salt is deposited onto at least a portion of a surface of the metal. At least a portion of the salt has a melting temperature T₁ that is less than T₂ and a boiling temperature T₅ that is greater than T₂. In another step the solid salt and the at least a portion of the surface of the metal are heated to a temperature T₃ that is equal to or greater than T₁ but less than T₅ until the solid salt melts on the metal to form a coated metal region.

An apparatus is also provided for coating a metal object with a salt. The apparatus has an applicator that is configured to deposit the salt onto a surface of the metal object to form a salted metal object. The apparatus also includes a furnace that is configured to receive the salted metal object and to melt at least a portion of the salt on the surface of the salted metal object. There is also a conveyor system that is configured to transport the metal object into and out of the applicator and configured to transport the salted metal object into and out of the furnace.

### BRIEF DESCRIPTION OF THE DRAWINGS

Various advantages are apparent by reference to the detailed description in conjunction with the figures, wherein elements are not to scale so as to more clearly show the details, wherein like reference numbers indicate like elements throughout the several views, and wherein:

FIG. 1 is a somewhat schematic depiction of a metal workpiece and a non-reactive support structure with a granulated salt mixture disposed thereon.

FIG. 2 is a somewhat schematic depiction of a coated metal workpiece.

FIG. 3 is a ternary eutectic diagram.

FIG. 4 is a somewhat schematic depiction of an automated system for applying a protective salt coating onto a metal object.

### DETAILED DESCRIPTION

In the following detailed description of the preferred embodiments, reference is made to the accompanying drawings, which form a part hereof, and within which are shown by way of illustration the practice of specific embodiments of processes for metal forming that reduce oxidation of the metal. It is to be understood that other embodiments may be utilized, and that processes may vary in other embodiments.

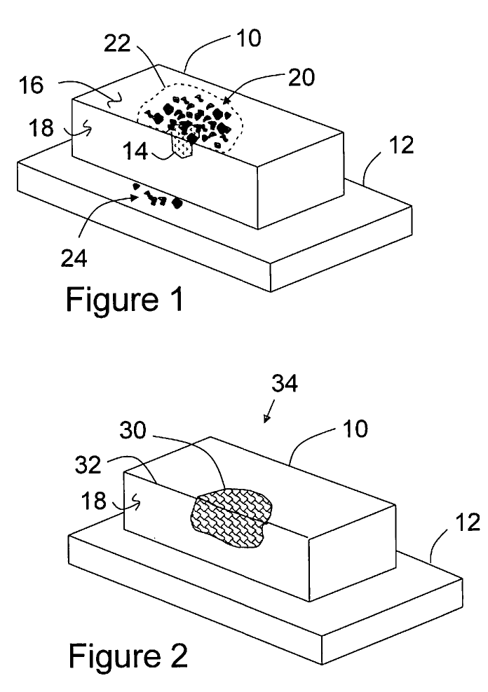

One embodiment provides a coating process for metal that reduces metal oxidation during hot working processes up to approximately 750° C. in air. Referring to FIG. 1, a metal workpiece 10 is disposed on a non-reactive support 12. The metal workpiece may be a ferrous, non-ferrous, refractory, or a rare earth metal, or virtually any other metal or alloy thereof. The non-reactive support 12 may be fabricated from a ceramic material or other material that will not react with other materials used in the coating process. A region 14 of the metal workpiece 10 is being prepared for a hammer forging operation in region 14 of the metal workpiece 10. In the embodiment depicted in FIG. 1, the region 14 of the metal workpiece 10 that is to be formed includes a portion of a top surface 16 and a portion of a side surface 18 of the metal workpiece 10. However, as used herein, the term “region” of a metal or metal workpiece refers to either (a) a portion of one or more surfaces of the metal or metal workpiece or (b) all surfaces of the metal or metal workpiece.

A solid-phase salt 20 is disposed onto a portion 22 of the top surface 16 of the metal workpiece 10. The salt 20 may be a single alkali metal carbonate salt or the salt 20 may be a salt mixture such as a mixture of lithium carbonate, potassium carbonate and sodium carbonate. In some embodiments the salt 20 may be a combination of one or more carbonate salts and one or more other salts, such as chloride or fluoride salts. The portion 22 of the top surface 16 whereupon the salt 20 is disposed should be selected to at least cover the region 14 of the metal workpiece 10 that will be subsequently heated for hammer forging. Typically the salt 20 is deposited onto the top surface 16 of the metal workpiece 10 at room temperature.

In many embodiments, the entire top surface 16 of the metal workpiece 10 may be covered with the salt 20. Control of the dispersion of the salt 20 onto the top surface 16 of the metal workpiece 10 is typically not critical. For example, as illustrated in FIG. 1, a granulated spillover salt 24 has been deposited on the non-reactive support 12, and such scattering is typically not detrimental to the process. The non-reactive support 12 may be fabricated from a ceramic or from another material that does not interfere with the salt coating process.

After depositing the salt 20 onto the top surface 16 of the metal workpiece 10, the region 14 of the metal workpiece 10 may be heated in an argon-flooded environment (or a vacuum or another environment designed to prevent oxidation of the metal workpiece 10) to a required working temperature. Environments designed to prevent oxidation of the metal workpiece 10 are referred to herein as “protective environments.” The working temperature is the temperature at which the metal forming operation (in this case, hammer forging) is to be performed. If the salt 20 is disposed on only a portion of the metal workpiece 10 (as illustrated in FIG. 1) the heating of the metal workpiece 10 should be performed only in the region 14. Such localized heating helps prevent oxidation of regions of the metal workpiece 10 that are not protected by the salt. A device such as an infrared quartz tube that heats localized regions of materials very quickly may be used to heat the region 14.

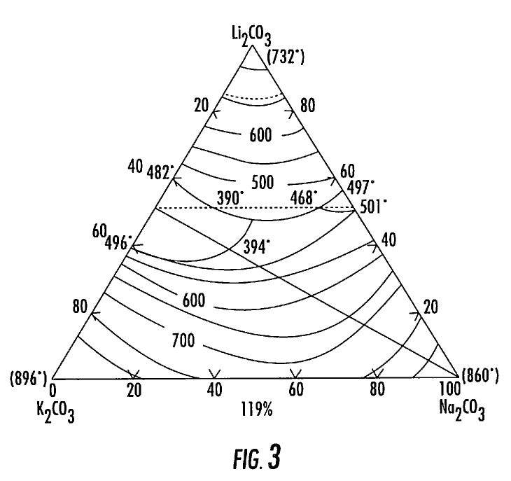

As the metal workpiece 10 is heated, the salt 20 melts at an intermediate temperature that is lower than the working temperature. Then, as shown in FIG. 2, a molten salt mixture 30 wets the surfaces of the region 14 (as seen in FIG. 1) of the metal workpiece that will subsequently be hammer forged. Because a sufficient quantity of salt 20 was applied to the top surface 16 of the metal workpiece 10, the molten salt mixture 30 has flowed over the edge 32 of the metal workpiece 10 onto the side surface 18 of the metal workpiece 10 thereby covering substantially all of the region 14 of the metal workpiece 10 that will subsequently be hammer forged. Other surfaces of the metal workpiece, including the underside of the metal workpiece 10 may also be wetted by a natural wicking action between the undersurface of the metal workpiece and the non-reactive support 12 upon which it rests. A salt-coated metal workpiece 34 is created when the salt 20 has been melted to form the molten salt mixture 30 and the molten salt mixture 30 has coated at least the region 14 of the metal workpiece 10 that will be subjected to metal forming.

After coating, the coated metal workpiece 34 and the salt 20 may be cooled to a temperature below the melting temperature of the salt 20. The salt then forms a solid layer of salt on the surface of the metal workpiece 34, and the metal workpiece 34 may be removed from the argon environment (or whatever protective environment was used) and stored for subsequent metal forming operations. Instead of cooling and storing, the coated metal workpiece 34 may be removed from the argon (or other protective) environment and further heated (if needed) to its working temperature. The hammer forging operation on the region 14 may then be performed in an active environment.

As used herein, the term “active environment” refers to an environment that would oxidize the metal workpiece 10 if the metal workpiece 10 were not protected by a coating. The conditions for an active environment are determined by the combination of (a) the nature of the specific atmosphere surrounding the metal, particularly the amount of oxygen present, and (b) the metal oxidation sensitivity temperature of the metal in that specific atmosphere. The metal oxidation sensitivity temperature of a metal is the temperature at which oxidation begins to form at a rate that is unacceptable for a particular metal in the specific atmosphere. In the process just described, the argon prevents oxidation of the metal workpiece 10 from room temperature up to the melting temperature of the salt 20. The molten salt mixture 30 acts as an anti-oxidizing protective barrier for the coated metal workpiece 34 from the melting temperature of the salt up to the boiling point of the salt 20.

In some embodiments a carbonate salt mixture is deposited onto a surface of a metal billet at room temperature in the ambient atmosphere. The billet is loaded into a furnace set at a temperature below the metal oxidation sensitivity temperature and the furnace is purged with argon until the atmosphere in the furnace is substantially inert. The furnace is then sufficiently energized to ramp up the temperature through the melting point of the carbonate salt. At this point the argon purge may be discontinued. The temperature is further ramped up to the required working temperature of the metal billet. The furnace may then be de-energized and the billet is hot-worked. The carbonate salt mixture remains wetted on the billet surface while the temperature is above the melting point of the carbonate salt mixture and remains on the billet after the salt solidifies, continually protecting the billet if the temperature of the billet decreases.

Another embodiment may be employed if the salt has a lower melting point than the metal oxidation sensitivity temperature. In this embodiment such a granulated salt mixture is deposited onto the surface of a metal workpiece, typically at room temperature. The metal workpiece may then be heated in ambient air until the salt melts. Heating continues above the temperature where oxidation of the metal workpiece would normally occur. However the metal workpiece does not oxidize to any significant extent because the surface of the metal workpiece is protected by the layer of molten salt. Heating of the metal workpiece and the molten salt layer continues to the desired working temperature of the metal workpiece and then the metal workpiece is formed while the salt mixture is molten. The formed metal workpiece is then cooled for use.

Various types of furnace systems may be used to heat the metal and the salt mixture, (examples are resistance, IR, microwave, etc.). After a metal is formed, any residual salt on the formed part may be removed after the metal is cooled, typically by washing/rinsing the metal in water. Ultrasonic activation of the water may be employed to speed up and improve cleaning.

Various combinations of salts may be used to achieve different melting points by way of eutectics. A metal having a comparatively low oxidation sensitivity temperature may be protected by a eutectic salt mixture having a low melting temperature so that the salt melts at a temperature below the oxidization sensitivity temperature. Likewise, eutectic mixtures of salts having comparatively high boiling points may be judiciously selected so that protection of a metal is not lost due to vaporization of the salt. The use of salts with comparatively high boiling points increases the maximum potential working temperature of the metal up to the boiling point of the salt, as long as the salt does not react or corrode the metal surface at the higher working temperature.

As previously indicated, a great variety of metals may be protected with embodiments provided herein. For example, ferrous, non-ferrous, refractory, or rare earth metals, or virtually any other metal or alloy thereof may be protected for metal forming. Mixtures of these metals, such as iron aluminides and titanium aluminides may be processed. Salt formulations for such combinations are selected dependent primarily upon the predominant metal of the alloy or mixture.

The selection of a particular salt or salt mixture depends in part upon the metal being processed. A single compound salt (e.g., technical grade sodium carbonate) is often the most economical choice, but sometimes a mixture is needed in order to meet specific fabrication needs. The salt or salt mixture that is selected should provide smooth wetting of the metal surface (as opposed to beading up on the surface) when the salt is molten. In addition, if the coating and forming processes will involve cooling the metal and salt to room temperature after wetting, the salt should have a coefficient of thermal expansion that is compatible with the metal so that cracks are not formed in the salt during solidification and reheating. Also, the salt selected should have a melting temperature that is below the working temperature of the metal and the salt selected should have a boiling temperature that is above the working temperature of the metal.

In some embodiments of systems and methods for protecting a metal from oxidation, a low-melting-temperature salt may replace a protective environment for protecting the metal above the metal's oxidation sensitivity temperature. For example, suppose the metal has a metal oxidation sensitivity temperature T₂. Suppose further that a solid salt is selected where least a first portion of which has a melting temperature T₁ that is less than T₂ and a boiling temperature T₅ that is greater than T₂. After this salt is deposited onto the metal the solid salt and the surface of the metal may then be heated to a temperature T₃ that is equal to or greater than T₁ until the solid salt melts on the metal to form a coated metal region. The molten salt protects the metal when the temperature of the metal is above its oxidation sensitivity temperature (T₂) as long as the temperature T₃ of the metal does not exceed the boiling temperature T₅ of the salt. At that temperature the salt would evaporate leaving the metal exposed for oxidation at a temperature above its oxidation sensitivity temperature (T₂). After the salt has melted on the surface of the metal the coated metal region may then optionally be cooled to a temperature below T₂ (or even below temperature T₁ where the salt solidifies) for temporary or long-term storage while awaiting subsequent metal forming operations.

Combinations of salt compounds may be used to protect wider ranges of temperatures. For example, a carbonate salt and a fluoride salt may be used in combination. The carbonate salt melts and protects the surface during comparatively low temperatures. As the temperature increases the fluoride salt melts, and as the temperature rises further the carbonate salt volatilizes but, as long as the temperature does not exceed the boiling point of the fluoride salt, the fluoride salt stays molten to continue to protect the metal surface.

For instance, continuing with the example from the paragraph before last, suppose that the metal has a working temperature T₆ that is higher than T₅, and suppose that the solid salt is a combination of salt compounds and at least a second portion of the combination of salt compounds has a melting temperature T₄ that is less than T₅ and has a boiling temperature T₈ that is above T₆. Then the coated metal region may be heated to a temperature T₇ that is equal to or above T₆ and below T₈ for metal forming with the part being protected from oxidation throughout the temperature rise. That is, at temperature T₅ a first portion of the combination of salts will boil off, but prior to that at least the second portion of the combination of salt compounds will have melted (at temperature T₄) and will protect the metal after the first portion of the combination of salt compounds boils off until the metal and the salt reaches the metal working temperature T₆. That second portion of the combination of salt compounds will continue to protect the metal above temperature T₆ as long as the temperature of the metal and the second portion of the combination of salt compounds is not raised to temperature T₈, because at temperature T₈ and above the second portion of the combination of salt compounds also boils off leaving the metal exposed for oxidation at a temperature above its oxidation sensitivity temperature (T₂).

As previously indicated, eutectic blends of salts may be used to tailor the melting temperature of a salt mixture. FIG. 3 presents a ternary eutectic diagram for mixtures of lithium carbonate, potassium carbonate and sodium carbonate salts. For example, to achieve a melting temperature of about 390° C., a combination of ≈52 wt % lithium carbonate, ≈24 wt % potassium carbonate, and ≈24 wt % sodium carbonate could be used. The individual salts are mixed in these ratios, melted together to produce a fused eutectic blend, then cooled to solid form, and then may be granulized for subsequent use as a eutectic blend of salts.

In some embodiments the salt may be mixed with a non-salt chemical to enhance performance of an oxidation protection system. One example is mixing a salt with a polymer having a carbon-carbon bond that produces an exothermic reaction when the polymer and the salt are heated. The exothermic reaction helps to heat the salt to its melting temperature. Another example is mixing a low-emissivity chemical, such as carbon, with the salt. The carbon absorbs infrared energy and heats the salt. Both the addition of an exothermic reaction chemical and the addition of a low-emissivity chemical are beneficial because they reduce the amount of furnace energy required to implement the oxidation protection system.

Some of the various embodiments described here (such as that depicted in FIG. 1) depict the use of granulated salt. In alternate embodiments any other physical form of solid-phase salt or salt mixture (such as a powder or a block) may also be used. The term “solid salt” is used herein to refer to any physical form of solid-phase salt or salt mixture (such as granulated, powdered or block salt). Also, the term “solid salt” encompasses a single compound salt, a combination of salt compounds, a eutectic blend of salts, combinations thereof, and combinations thereof with or without one or more non-salt chemicals. Solid salts that exclude any significant amount of non-salt chemicals are referred to as “plain solid salts.”

Generally, any salt that is appropriate for salt bath heat treatment of a metal may be pulverized (if needed) and used as a solid salt for protecting that metal from oxidation. Salt mixtures that may be used for oxidation protection of iron or ferrous alloys typically include alkali metal chlorides (e.g., lithium chloride, potassium chloride) and alkali metal carbonates (e.g., potassium carbonate, sodium carbonate, and lithium carbonate). Often an alkali metal cyanide is included because cyanides are particularly strong chemical reducing agents. However, extreme caution is required when using any cyanide salt due to potentially fatal cyanide toxicity. Salts used for nitriding metals may also be used for oxidation protection. Very little nitriding occurs when these salts are used in embodiments described herein because of the low volume of nitrogen provided by a molten layer of salt compared with the amount of nitrogen active on the surface of a metal in a molten bath of salt. The compositions of commercial nitride salt baths are generally proprietary. Reportedly one salt that is used for nitriding steel includes (a) 60 to 70% (by weight) sodium salts that consist of 96.5% NaCN, 2.5% Na₂CO₃, and 0.5% NaCNO and (b) 30 to 40% potassium salts consisting of 96% KCN, 0.6% K₂CO₃, 0.75% KCNO, and 0.5% KCl. The typical operating temperature of this salt bath is 565° C. Another salt bath used for nitriding is reportedly composed of 60 to 61% NaCN, 15.0 to 15.5% K₂CO₃, and 23 to 24% KCl.

Granulated salts that are used for oxidation protection of aluminum typically include alkali metal chlorides (e.g., lithium chloride, potassium chloride), alkali metal nitrates (e.g. potassium nitrate, sodium nitrite) and alkali metal carbonates (e.g., sodium carbonate, lithium carbonate, and potassium carbonate). Granulated salts used for oxidation protection of copper or brass include alkali metal chlorides (e.g., lithium chloride, potassium chloride). Granulated salts used for oxidation protection of titanium typically include an alkali metal chloride salt (e.g., lithium chloride); sodium hydroxide may be added as a non-salt chemical.

While various alkali (Group I) salts have been heretofore identified for application in embodiments herein, any alkaline (Group II) salt or any other metal salt may also be used.

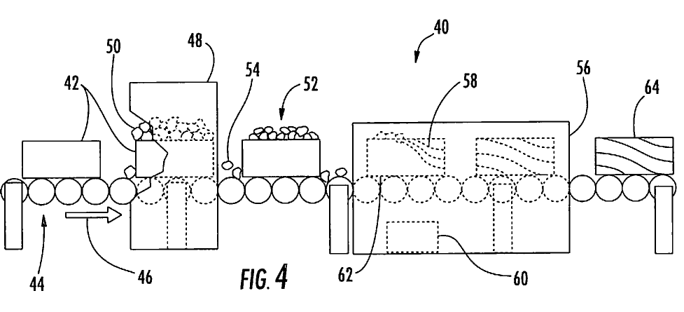

The method embodiments described herein for protecting the surface of a metal for metal forming may be implemented by various automated system embodiments. An example of such an automated system is a coating apparatus 40 that is illustrated in FIG. 4. Metal objects 42 are placed on a conveyor system 44. As used herein the term “metal object” refers to an object that may be composed entirely of metal or may be composed of a combination of one or more non-metallic materials with metal on at least part of the surface of each object. The conveyor system 44 may be a motorized chain belt, a series of rollers (motorized or free-wheeling), a slide, or a similar apparatus. The conveyor system 44 moves the metal objects 42 in the direction 46 into and out from a salt applicator 48. The salt applicator 48 deposits salt 50 onto at least a portion of the metal exposed on the surface of the metal objects 42, forming salted metal objects 52. Spillover salt 54 from the salt applicator 48 typically falls onto the conveyor system 44. The conveyor system 44 transports the salted metal objects 52 into a furnace system 56. The conveyor system 44 may transport at least a portion of the spillover salt 54 into and out of the furnace system 56. The furnace system 56 may be a uniformly-heated oven, or a zone furnace, or a very localized-heating device such as an infrared lamp or a laser.

The furnace system 56 melts at least a portion of the salt 50 forming molten salt 58 on at least a portion of the surfaces of the salted metal objects 52. The furnace system 56 includes an inert atmosphere source 60 that is configured to maintain an inert atmosphere around the salted metal objects 52 while they are being heated, before the molten salt 58 protects the surfaces of the salted metal objects 52 from oxidation. In the embodiment of FIG. 4 the furnace also melts at least a portion of the spillover salt 54 to coat at least a portion of the underside 62 of the salted metal objects 52. In alternative embodiments, only a portion or none of the spillover salt 54 may be transported by the conveyor system 44. A portion of the molten salt 58 may flow onto the conveyor system 44 and coat at least a portion of the underside 62 of the salted metal objects 52. As seen in FIG. 4, a coated metal object 64 is transported out of the furnace system 56 by the conveyor system 44. In some embodiments the coated metal object 64 may be turned upside down and re-processed through the original coating apparatus 40 (or processed through a duplicate coating apparatus) to ensure that the underside 62 of the salted (now coated) metal object 64 is fully coated.

In summary, several embodiments are disclosed herein to provide processes for metal forming that minimize metal oxidation. The processes include methods for coating metal (workpieces, billets, etc.) with salt that is melted onto the metal surfaces. Coated metal objects are also disclosed, as are apparatuses for coating metal objects with salt.

The foregoing descriptions of embodiments of this invention have been presented for purposes of illustration and exposition. They are not intended to be exhaustive or to limit the invention to the precise forms disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A process for protecting metal from oxidation, the process comprising:
(a) depositing a solid salt onto at least a portion of a surface of a metal;
(b) heating the solid salt and the at least a portion of the surface of the metal in a protective environment until the solid salt melts on the metal to form a coated metal region; and
(c) exposing the coated metal region to an active environment.

2. The process of claim 1 further comprising a step (b-1) comprising cooling the coated metal region to ambient temperature.

3. The process of claim 2 further comprising a step (c-1) comprising heating the coated metal region to a working temperature.

4. The process of claim 1 wherein:
step (a) comprises depositing a solid salt comprising an alkali metal carbonate onto at least a portion of a surface of iron or a ferrous alloy;
step (b) comprises heating the solid salt and the at least a portion of the surface of the iron or ferrous alloy in an inert environment until the solid salt melts on the iron or ferrous alloy to form a coated iron or ferrous alloy region; and
step (c) comprises exposing the coated iron or ferrous alloy region to an active environment.

5. The process of claim 4 wherein step (a) comprises depositing a solid salt comprising an alkali metal carbonate and an alkali metal cyanide onto at least a portion of a surface of the iron or a ferrous alloy.

6. The process of claim 1 wherein:
step (a) comprises depositing a solid salt comprising an alkali metal chloride onto at least a portion of a surface of aluminum or an aluminum alloy;
step (b) comprises heating the solid salt and the at least a portion of the surface of the aluminum or aluminum alloy in an inert environment until the solid salt melts on the aluminum or aluminum alloy to form a coated aluminum or aluminum alloy region; and
step (c) comprises exposing the coated aluminum or aluminum alloy region to an active environment.

7. The process of claim 6 wherein step (a) comprises depositing a solid salt comprising lithium chloride onto at least a portion of a surface of aluminum or an aluminum alloy.

8. The process of claim 1 wherein:
step (a) comprises depositing a solid salt comprising an alkali metal nitrate onto at least a portion of a surface of aluminum or an aluminum alloy;
step (b) comprises heating the solid salt and the at least a portion of the surface of the aluminum or aluminum alloy in an inert environment until the solid salt melts on the aluminum or aluminum alloy to form a coated aluminum or aluminum alloy region; and
step (c) comprises exposing the coated aluminum or aluminum alloy region to an active environment.

9. The process of claim 1 wherein:
step (a) comprises depositing a solid salt comprising an alkali metal carbonate onto at least a portion of a surface of aluminum or an aluminum alloy;
step (b) comprises heating the solid salt and the at least a portion of the surface of the aluminum or aluminum alloy in an inert environment until the solid salt melts on the aluminum or aluminum alloy to form a coated aluminum or aluminum alloy region; and
step (c) comprises exposing the coated aluminum or aluminum alloy region to an active environment.

10. The process of claim 1 wherein:
step (a) comprises depositing a solid salt comprising an alkali metal chloride onto at least a portion of a surface of copper or a copper-based alloy;
step (b) comprises heating the solid salt and the at least a portion of the surface of the copper or copper-based alloy in an inert environment until the solid salt melts on the copper or copper-based alloy to form a coated copper or copper-based alloy region; and
step (c) comprises exposing the coated copper or copper-based alloy region to an active environment.

11. The process of claim 1 wherein:
step (a) comprises depositing a solid salt comprising sodium hydroxide onto at least a portion of a surface of titanium or a titanium alloy;
step (b) comprises heating the solid salt and the at least a portion of the surface of the titanium or titanium alloy in an inert environment until the solid salt melts on the titanium or titanium alloy to form a coated titanium or titanium alloy region; and
step (c) comprises exposing the coated titanium or titanium alloy region to an active environment.

12. The process of claim 11 wherein step (a) comprises depositing a solid salt comprising sodium hydroxide and sodium nitrate onto at least a portion of a surface of the titanium or a titanium alloy.

13. A process for protecting a metal from oxidation, the metal having a metal oxidation sensitivity temperature T₂, the process comprising:
(a) depositing a solid salt onto at least a portion of a surface of the metal wherein at least a portion of the salt has a melting temperature T₁ that is less than T₂ and a boiling temperature T₅ that is greater than T₂; and
(b) heating the solid salt and the at least a portion of the surface of the metal to a temperature T₃ that is equal to or greater than T₁ but less than T₅ until the solid salt melts on the metal to form a coated metal region.

14. The process of claim 13 wherein the metal has a working temperature T₆ that is higher than T₅, and wherein the solid salt is a combination of salt compounds and a portion of the combination of salt compounds has a melting temperature T₄ that is less than T₅ and a boiling temperature T₈ that is above T₆, and wherein the process further comprises a step (c) heating the coated metal region to a temperature T₇ that is equal to or above T₆ and below T₈ for metal forming.

15. The process of claim 13 further comprising a step (b-1) after step (b), wherein step (b-1) comprises cooling the coated metal region to a temperature below T₂.

16. An apparatus for coating a metal object with a salt, the apparatus comprising:
an applicator configured to deposit the salt onto a surface of the metal object to form a salted metal object;
a furnace configured to receive the salted metal object and to melt at least a portion of the salt on the surface of the salted metal object; and
a conveyor system configured to transport the metal object into and out of the applicator and configured to transport the salted metal object into and out of the furnace.

17. The apparatus of claim 16 wherein:
the metal object has an undersurface;
the applicator is further configured to deposit spillover salt onto the conveyor system;
the conveyor system is further configured to transport at least a portion of the spillover salt into the furnace; and
the furnace is further configured to melt at least a portion of the spillover salt wherein at least a portion of the undersurface of the metal object is coated with molten salt.
